(19) United States
(12) Patent Application Publication
(10) Pub. No.: US 2004/0219002 A1
(43) Pub. Date: Nov. 4, 2004

(54) Transportable manufacturing system

(76) Inventors: Sonny Lenaers, Maasmechelen (BE); Dirk Theunissen, Maasmechelen (BE)

Correspondence Address: NIXON & VANDERHYE, PC, 1100 N GLEBE ROAD, 8TH FLOOR, ARLINGTON, VA, 22201-4714, US

(21) Appl. No.: 10/426,967

(22) Filed: May 1, 2003

(51) Int. Cl. B60B 29/00

(52) U.S. Cl. 414/459

(57) ABSTRACT

A transportable manufacturing system is provided for lifting and positioning a load. The system includes a first support member and a second support member separate and independent from the first support member. Each of the support members includes a support base and a load supporting frame coupled with the support base. The load supporting frame contains a movable load coupling attachable to the load, wherein each support base includes at least one selectively operable air bearing that generates an air cushion for supporting the first and second support members, respectively. The system can be readily positioned within a manufacturing facility or even relocated from one facility to another. Additionally, the system occupies less space than conventional machinery.

### CROSS-REFERENCES TO RELATED APPLICATIONS

(Not Applicable)

### STATEMENT REGARDING FEDERALLY SPONSORED RESEARCH OR DEVELOPMENT

(Not Applicable)

### BACKGROUND OF THE INVENTION

The present invention relates to a multi-component transportable manufacturing system and, more particularly, to a transportable manufacturing system including components for supporting and positioning a load, which components are separately movable via an air bearing.

In any manufacturing process, it is desirable to be able to easily manipulate the item being manufactured. In the case of manufacturing items of excessive weight, such as for example, vehicles, engines, etc., it is necessary to employ some type of machinery to enable lifting and positioning of the item. Generally, it is desirable to enable a working platform to access the underside of a vehicle, thus requiring the ability to lift and rotate a vehicle or like load.

Machinery for lifting and manipulating heavy loads is well known. Typically, however, such machinery is quite large and itself of excessive weight, thereby taking up valuable space in a manufacturing facility while being practically impossible to move from one facility to another or even from one location to another in the same facility. Moreover, often systems utilize a channel in the floor, but obviously such systems are not readily movable for reconfiguring an assembly line or moving to another location if necessary.

### BRIEF SUMMARY OF THE INVENTION

It would thus be desirable for a manufacturing system capable of lifting and positioning a load to be easily transportable. Additional advantages could be achieved if the system was also reduced in size relative to existing machinery in order to occupy less floor space.

A manufacturing system of the invention includes a pair of facing supports, which cooperate to enable lifting and positioning of a load such as vehicle or the like for manufacture, repair, etc. Each of the supports may be provided at its base with a system generating an air cushion enabling independent transport of the respective supports either from one position to another or one manufacturing facility to another.

In an exemplary embodiment of the invention, a transportable manufacturing system for lifting and positioning a load includes a first support member and a second support member separate and independent from the first support member. Each of the first and second support members includes a support base and a load supporting frame coupled with the support base, and each load supporting frame comprises a movable load coupling attachable to the load. Each support base includes at least one selectively operable air bearing that generates an air cushion for supporting the first and second support members, respectively. The first and second support members are preferably functionally cooperable by supporting opposite ends of the load.

Each load supporting frame may include two load coupling support rails, wherein the load coupling is secured to the load supporting frame via the support rails for reciprocating displacement along the support rails. In this context, each of the first and second support members preferably further includes a lifting mechanism coupled with each load supporting frame, respectively, that drives the load coupling along the support rails. The lifting mechanism may comprise a threaded rod coupled for rotation by a motor.

Each load coupling may include a load mount that is rotatable about an axis substantially perpendicular to the support rails. In this context, the load mount of the first support member may be driven by a motor.

Generally, each load supporting frame preferably comprises structure for movably supporting the load coupling in at least two degrees of freedom. Moreover, the movably supporting structure may support the load coupling for substantially vertical displacement and for rotation about a longitudinal axis of the load.

Each support base preferably includes four air bearings disposed substantially at each of four corners of each support base. Using four air bearings facilitates independent movability of the supports.

In another exemplary embodiment of the invention, a modular manufacturing facility includes a plurality of the transportable manufacturing systems of the invention for lifting and positioning a respective load defining an assembly line. The modular manufacturing facility may further include an air compressor serving as a source of compressed air for each of the plurality of transportable manufacturing systems, wherein the air bearings comprise pneumatic drive motors coupled with the air compressor.

### BRIEF DESCRIPTION OF THE DRAWINGS

These and other aspects and advantages of the present invention will be described in detail with reference to the accompanying drawings, in which:

FIG. 1 is a front view of one of the two support members that make up the transportable manufacturing system of the present invention;

FIG. 2 is a side view of the transportable manufacturing system supporting a load; and

FIG. 3 is a plan view of the system shown in FIG. 2.

### DETAILED DESCRIPTION OF PREFERRED EMBODIMENTS

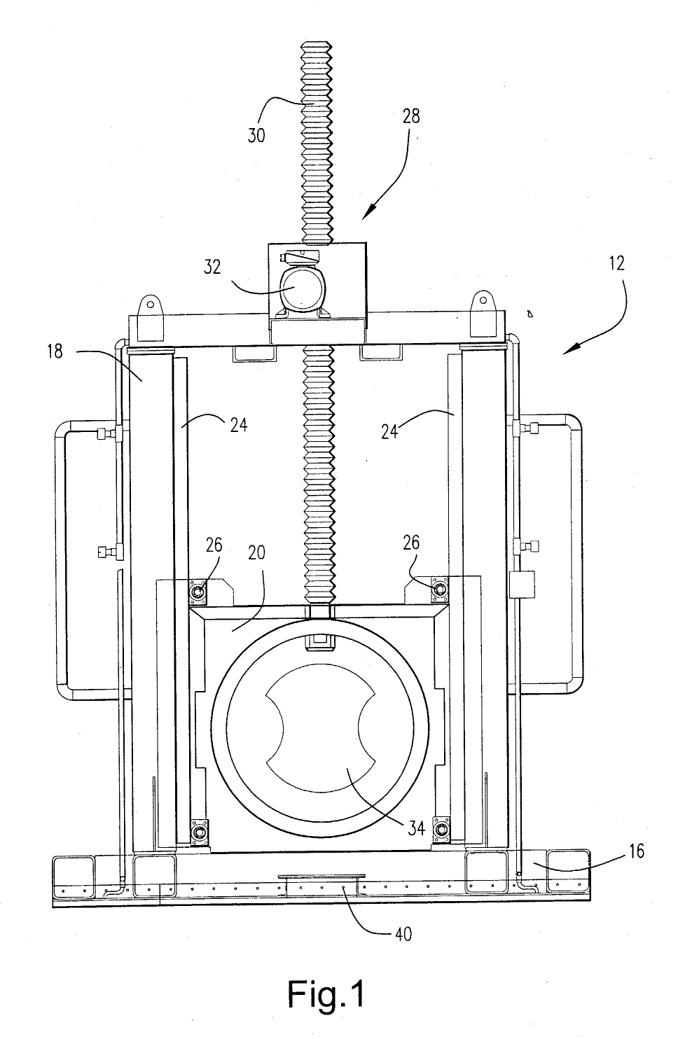

In FIGS. 1-3, the transportable manufacturing system of the present invention is shown with the load illustrated as a vehicle. This exemplary load, however, is for illustration purposes only as the system can be configured for manipulating a load of any practicable size and shape. The invention is thus not meant to be limited to the illustrated example.

With reference to the FIGURES, the transportable manufacturing system 10 of the present invention comprises a first support member 12, and a second support member 14 separate and independent from the first support member 12. With only minor exceptions, which will be described in detail below, the first support member 12 and the second support member 14 generally comprise similar components. Only the first support member 12 will thus be described in detail with reference to FIG. 1, it being understood that the described components are also included as part of the second support member 14.

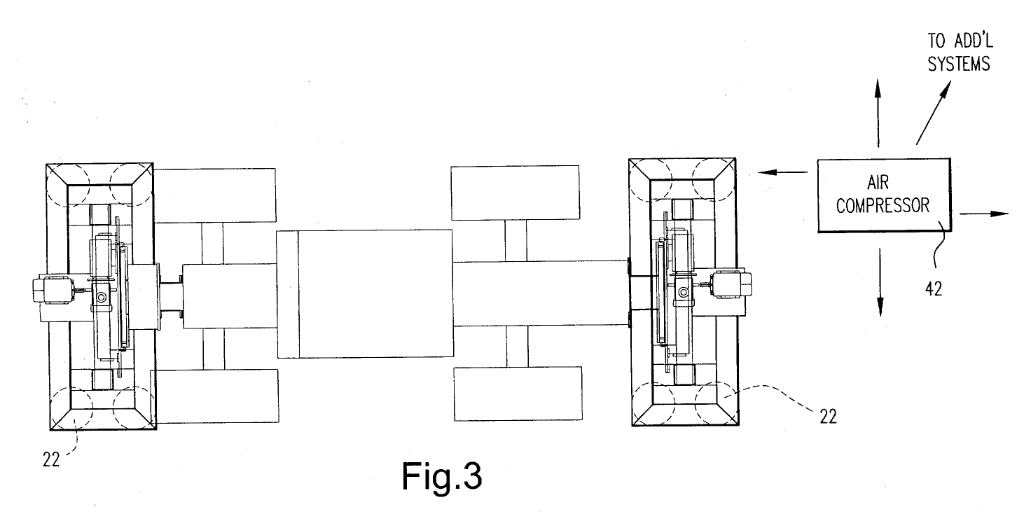

Generally, each of the support members 12, 14 includes a support base 16 and a load supporting frame 18 coupled with the support base 16. Each load supporting frame 18 includes a movable load coupling 20 that is attachable to the load L. As particularly shown in FIG. 3, each support base 16 includes at least one, preferably four, selectively operable air bearings 22 that generate an air cushion for supporting the support members 12, 14. The specific structure and operation of the air bearings 22 are known and do not specifically form part of the present invention. As a consequence, the details thereof will not be further described. One suitable air bearing is the ST-1-A25N manufactured by Aerofilm Systems BV of The Netherlands.

With continued reference to FIG. 1, the load supporting frame includes two load coupling support rails 24 secured vertically between top and bottom portions of the load supporting frame 18. The load coupling 20 is movably secured to the support rails 24 via a plurality of bearings 26 disposed adjacent corners of the load coupling 20, respectively. The bearings 26 may be any suitable structure that will enable the load coupling 20 to reciprocate between upper and lower positions within the load supporting frame 18. Examples of suitable bearings 26 may include rollers, ball bearings, friction bearings, and the like.

A lifting mechanism 28 includes a threaded rod 30 coupled with the load coupling 20 at a top portion thereof as shown in FIG. 1. The lifting mechanism 28 also includes a motor 32 coupled with the threaded rod 30 for driving the threaded rod in forward and reverse directions, thereby raising and lowering the load coupling 20. The connection between the threaded rod 30 and the load coupling 20 is made in such a way that small reciprocating movement is possible, obviating problems with system-wide tolerances. The motor 32 may be any type suitable for the described purpose such as, for example, an electric motor, although a hydraulic motor or other type may also be suitable. An electric motor is preferred because there generally is nothing else hydraulic in the system, and electrical synchronization between the two motors is easier than hydraulic synchronization, which requires hydraulic connections between both supports. An alternative for the threaded rod and motor could be a hydraulic cylinder, moving the load coupling 20 up and down. In this context, however, added safety features would need to be installed to prevent load coupling 20 from coming down in case of an oil leak, or other problem in the hydraulic system.

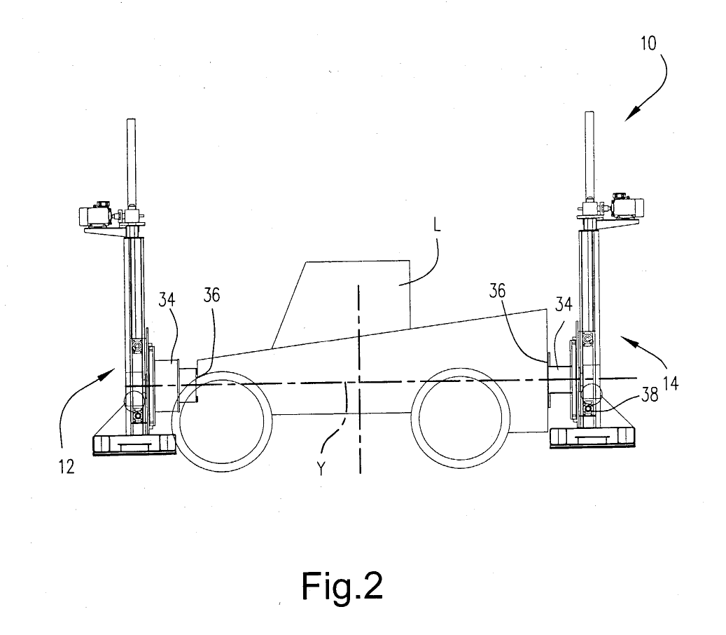

Each load coupling additionally includes a load mount 34 including structure such as a bolt plate 36 for direct mounting to the load L via bolts or the like. The load mounts 34 are secured in the load coupling 20 via a suitable bearing assembly such that the load mount 34 is rotatable about a longitudinal axis Y (FIG. 2) of the load L substantially perpendicular to the support rails 24. In a preferred arrangement, the load mount 34 of the second support member 14 is rotatably driven by a motor 38 while the load mount 36 of the first support member 12 merely follows that of the second support member 14. These load mounts are mounted to the load coupling preferably using turntable bearings, from which one can turn freely and follow the other, which is driven by the motor 38. See FIG. 2.

With the structure of the transportable manufacturing system of the invention, the first and second support members 12, 14 are functionally cooperable by supporting opposite ends of the load L while being separate and independent from each other when disconnected from the load L. Such construction coupled with the use of the air bearings 22 in each support base 16 enables the system of the invention to be readily transportable either from one position to another or even one manufacturing facility to another. The air bearings 22 are each capable of supporting upwards of four tons, and thus the first and second support members 12, 14 are readily movable even with the load L attached.

A modular manufacturing facility may comprise a plurality of the transportable manufacturing systems 10 of the present invention. The plurality of systems may serve to define a manufacturing assembly line. The air bearings 22 in each support base 16 are preferably driven by pneumatic drive motors 40 suitable for the described purpose, which are coupled with a source of compressed air 42. The pneumatic drive motors 40 also work as safety devices, whereby the supports carrying the load L cannot drift away on an unlevel floor when a rubber wheel of the drive motor is in contact with the floor. In the modular manufacturing facility, the air compressor 42 may be disposed outside of the facility to reduce noise with separate air delivery conduits secured through each pneumatic motor 40. Alternatively, each system 10 may include its own air compressor. With the transportable manufacturing systems 10 as part of the modular manufacturing facility, the facility can be readily relocated simply by activating the air bearings and loading the respective first and second support members 12, 14 onto a truck bed or the like. The support bases 16 may also be provided with openings for receiving forks of a forklift if desirable. The air bearings 22 are independently actuatable and via the respective pneumatic drive motors 40 assist in driving the first and second support members 12, 14 in various directions as well as stopping the support members. With this construction, the entire facility can be moved from one location to another with little difficulty.

In one arrangement, only the first support member 12 has a pneumatic drive motor 40 to move along a single axis, i.e., forward or reverse, while turning is done by hand. The second support member 14 may be a follower, but can alternatively be equipped with a second pneumatic drive motor, mounted perpendicular to the first one for movement along a perpendicular axis, i.e., left and right. With this arrangement, the supports and load can be moved forward and reverse and turned pneumatically, using no hand force.

The transportable manufacturing system of the present invention is capable of advantageously lifting and positioning a load while being readily transportable via air bearings and occupying less space than conventional machinery. The system can thus form part of a modular manufacturing facility that can be readily moved from one location to another and easily configured.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A transportable manufacturing system for lifting and positioning a load, the manufacturing system comprising a first support member and a second support member separate and independent from the first support member, wherein each of the first and second support members includes a support base and a load supporting frame coupled with the support base, each load supporting frame comprising a movable load coupling attachable to the load, wherein each support base comprises at least one selectively operable air bearing that generates an air cushion for supporting the first and second support members, respectively.

2. A transportable manufacturing system according to claim 1, wherein the first and second support members are functionally cooperable by supporting opposite ends of the load.

3. A transportable manufacturing system according to claim 1, wherein each load supporting frame comprises two load coupling support rails, and wherein the load coupling is secured to the load supporting frame via the support rails for reciprocating displacement along the support rails.

4. A transportable manufacturing system according to claim 3, wherein each of the first and second support members further comprises a lifting mechanism coupled with each load supporting frame, respectively, the lifting mechanism driving the load coupling along the support rails.

5. A transportable manufacturing system according to claim 4, wherein the lifting mechanism comprises a threaded rod coupled for rotation by a motor.

6. A transportable manufacturing system according to claim 3, wherein each load coupling comprises a load mount that is rotatable about an axis substantially perpendicular to the support rails.

7. A transportable manufacturing system according to claim 6, wherein the load mount of the first support member is driven by a motor.

8. A transportable manufacturing system according to claim 1, wherein each load supporting frame comprises means for movably supporting the load coupling in at least two degrees of freedom.

9. A transportable manufacturing system according to claim 8, wherein the movably supporting means supports the load coupling for substantially vertical displacement and for rotation about a longitudinal axis of the load.

10. A transportable manufacturing system according to claim 1, wherein each support base comprises four air bearings disposed substantially at each of four corners of each support base.

11. A modular manufacturing facility comprising a plurality of transportable manufacturing systems for lifting and positioning a respective load defining an assembly line,
each of the transportable manufacturing systems comprising a first support member and a second support member separate and independent from the first support member,
wherein each of the first and second support members includes a support base and a load supporting frame coupled with the support base, each load supporting frame comprising a movable load coupling attachable to the load,
wherein each support base comprises at least one selectively operable air bearing that generates an air cushion for supporting the first and second support members, respectively.

12. A modular manufacturing facility according to claim 11, further comprising an air compressor serving as a source of compressed air for each of the plurality of transportable manufacturing systems, wherein the air bearings comprise pneumatic drive motors coupled with the air compressor.
